(19) United States
(12) Patent Application Publication
(10) Pub. No.: US 2006/0028329 A1
(43) Pub. Date: Feb. 9, 2006

(54) Automobile day and evening sensory detector for the interior console

(76) Inventor: Sherri Marie Carr, Roswell, GA (US)

Correspondence Address: Sherri Marie Carr, 7744 Georgetown Chase, Roswell, GA, 30075, US

(21) Appl. No.: 10/679,309

(22) Filed: Oct. 7, 2003

(51) Int. Cl. B60Q 1/00; G08B 21/00

(52) U.S. Cl. 340/438; 340/641

(57) ABSTRACT

The technical disclosure of the invention would be determined by the applicable car companies/designers as they incorporate this idea into their designs for new car prototypes or for revamping current cars they have on the market. It would also be possible to market this product separately through local stores as an item you could use in older version cars made without this mechanism. Things that are new in the art applicable to the invention; technology has grown leaps and bounds (I.e the north star system). Following suit, it is feasible, relatively simple, and would benefit individuals driving, producing, and servicing cars. Among other things it would benefit our economy. This would have the potential of being patented in various countries according to their manufacturing and governing standards.

USPTO Patent Database Research shows there are no patents on this invention idea to date. Attached is the printed out statement from the applicable search.

There would be many benefits associated with this product:

Just a few of the multitude of benefits:
1. More jobs
   a. Creation of different designs for all manufacturers
   b. Production
   c. Service
   d. An additional marketing feature
2. Light Supply companies would benefit with an increase in sales
3. Less safety hazards
4. Better driving conditions for both automobile operators as well as other cars
5. Providing drivers with the knowledge of when their lights are operational (instead of having to rely on being pulled over by law enforcement officials and being cited with tickets; or relying on the kindness of strangers to inform you while you are driving; etc.)
6. Increased revenue for car companies
   a. Happier more loyal customers
   b. More service revenue
   c. Increased sales
   d. Word of mouth
   e. Makes their car look better to other potential customers rather than seeing a beautiful car driving down the road with only one of the lights or all of the lights malfunctioning
7. Better Economy

### BACKGROUND OF THE INVENTION

A. This endeavor pertains to the automobile industry.

B. This invention would resolve the problem of cars operating with headlights, taillights, turning signals, fog lights, and all encompassing lighting components on the exterior of the automobile that have burn out or are malfunctioning during the daytime and evening unbeknownst to the driver.

### BRIEF SUMMARY OF THE INVENTION

A system to detect when the car headlights, taillights, turning signals, fog fights, and all encompassing lighting components on the exterior of the automobile are operational and indicate when there is a malfunction.

For both daylights and evening lights

To be located in the interior of the car on the console panel section

### DETAILED DESCRIPTION OF THE INVENTION

A. This would be an improvement on the interior console, exterior lighting systems, and technological make-up of the car operating system.

B. Specifically, the interior console of the car would be outfitted with a mechanism that would indicate when a light has become inoperable or is malfunctioning.

C. This would apply for day and evening lights, headlights, taillights, turning lights, fog lights, and all lights inclusive of the car operating system.

1. What I claim as my invention is a section on the automobile interior console that would alert a malfunction on any of the lighting devices located on the inside and outside of the car.
